(19) United States
(12) Patent Application Publication
(10) Pub. No.: US 2008/0052446 A1
(43) Pub. Date: Feb. 28, 2008

(54) Logical super block mapping for NAND flash memory

(75) Inventors: Menahem Lasser, Kohav Yair (IL); Ronen Golan, Petah-Tikva (IL)

Correspondence Address: MARK M. FRIEDMAN, C/O DISCOVEY DISPATCH , 9003 FLIRIN WAY, UPPER MARLBORO, MD, 20772, US

(73) Assignee: SANDISK IL LTD.

(21) Appl. No.: 11/704,289

(22) Filed: Feb. 9, 2007

Related U.S. Application Data
(60) Provisional application No. 60/823,661, filed on Aug. 28, 2006.

(51) Int. Cl. G06F 12/06

(52) U.S. Cl. 711/103

(57) ABSTRACT

Increased capacity of a NAND flash memory may be achieved by increasing the availability of non-defective physical blocks by allowing logical super blocks to have physical blocks with different associated position numbers within the physical blocks' respective planes. A flash memory module has one or more flash memory integrated circuits (ICs), each having multiple physical blocks. The physical blocks are grouped into planes characterized in that only physical blocks from different planes can be erased simultaneously. Embodiments of the invention include a method of managing the physical blocks of the flash memory, a flash memory system for managing data transfer between a host and the flash memory ICs, and a machine readable storage medium containing instructions for a controller in the management of physical blocks of flash memory.

### RELATED APPLICATION

This application claims priority under 35 U.S.C. § 119(e) to U.S. Provisional Application No. 60/823,661, filed Aug. 28, 2006, which is hereby incorporated by reference in its entirety.

### BACKGROUND

NAND flash memory is used in environments where nonvolatility is desired, such as in personal computers and digital cameras. FIG. 1 depicts a prior art system 10, in which a host 12 reads, writes, and erases the data of a flash memory module 14 by interfacing through a controller 16. Controller 16 and flash memory module 14 may be implemented together in a single flash memory device. Alternatively, controller 16 may be implemented instead in software residing on host 12.

In a NAND flash memory device, erase operations are generally slow (typically 2 msec.) and can significantly reduce the performance of a system utilizing flash memory as its mass storage. Bytes of data are grouped into “pages,” and pages of data are grouped into arrays of “blocks.” Formerly, only one block of data in a NAND flash memory integrated circuit (IC) could be erased at a time, and system performance speeds were limited accordingly.

To decrease the time required to erase data stored in NAND flash memory, some prior art systems configured their memories as shown in FIG. 2. Here, a flash memory module 14a comprises multiple flash memory integrated circuits (ICs) 14a₁, 14a₂, 14a₃, . . . , 14a_{N}. The memory blocks of flash memory IC 14a₁ are designated 14a₁, 14a₁₂, 14a₁₃, . . . , 14a_{1M}, the memory blocks of flash memory IC 14a₂ are designated 14a₂₁, 14a₂₂, 14a₂₃, . . . , 14a_{2M}, and so on.

Although two blocks from the same flash memory IC cannot be erased simultaneously in systems 10 that use memory module such as flash memory module 14a, multiple blocks from different flash memory ICs can be erased simultaneously. For example, although memory blocks 14a₁₁ and 14a₁₂ of flash memory IC 14a₁ cannot be erased simultaneously, memory blocks 14a₁₁, 14a₂₁, 14a₃₁, . . . , 14a_{N1} can be erased simultaneously. Thus, the configuration of flash memory module 14a allows more blocks of memory to be erased simultaneously by using multiple flash memory ICs in place of a single flash memory IC having the same number of memory blocks.

In the present disclosure, the term “simultaneously” is used synonymously with “substantially simultaneously,” which acknowledges the potential slight offset in erasure periods of different blocks. Controller 16 may send erasure commands to the blocks at times that differ by a small amount. Nonetheless, an overlapping exists of the time periods that multiple blocks are being erased, so this erasure is regarded as simultaneous or substantially simultaneous.

Each memory block of flash memory module 14a has an associated position number, which indicates the block's physical location within its respective flash memory IC. Specifically, memory blocks 14a₁₁, 14a₁₂, 14a₁₃, . . . , 14a_{1M}, have associated position numbers 1, 2, 3, . . . , M, respectively, memory blocks 14a₂₁, 14a₂₂, 14a₂₃, . . . , 14a_{2M}, also have associated position numbers 1, 2, 3, . . . , M, respectively, and so on.

Initially after the manufacture of a flash memory IC, the memory block with position number 1 will be at the beginning of the block array, the memory block with position number 2 will be adjacent memory block 2, the memory block with position number 3 will be adjacent memory block 2, and so on. Thus, the position number of a memory block is a clear indication of the block's physical location within its respective flash memory IC. However, if defective blocks are discovered during the factory preliminary testing, the flash memory IC is modified to substitute reserve blocks from another section of the flash memory IC for the defective blocks. Therefore, the block having the position number 2 may not be physically located between the blocks with position numbers 1 and 3. Nonetheless, the corrective substitution is known and does not change, so the position number is still indicative of the block's physical location within its respective flash memory IC.

Memory blocks 14a₁₁, 14a₁₂, 14a₁₃, . . . , 14a_{1M} of flash memory module 14a have physical block addresses, which are used for memory management. FIG. 3 shows a representation of flash memory module 14a with the physical block addresses indicated for each memory block shown in FIG. 2. As is apparent, memory blocks 14a₁₁, 14a₁₂, 14a₁₃, . . . , 14a_{1M}, have physical block addresses 11, 12, 13, . . . , 1M, respectively, memory blocks 14a₂₁, 14a₂₂, 14a₂₃, . . . , 14a_{2M}, have physical block addresses 21, 22, 23, . . . , 2M, respectively, and so on. These physical block addresses identify the “physical blocks” of flash memory ICs 14a₁, 14a₂, 14a₃, . . . , 14a_{N}.

When accessing (reading, writing, . . . ) the storage area of memory module 14a, host 12 does not use the physical block addresses to reference the blocks. Instead, host 12 uses “logical block addresses,” which are mapped by controller 16 to physical block addresses. Because storage cells of a flash memory IC sometimes become defective during use, the one-to-one correspondence between logical and physical block addresses may change during the lifetime of flash memory module 14a. The mapping conversions performed by controller 16 changes accordingly. The physical block addresses of the physical blocks of flash memory module 14a however do not change. Unlike the operations performed in a factory setting, reserve blocks in an individual flash memory IC are not substituted for deflective blocks after the flash memory IC is released for use. The position numbers remain indicative of a block's physical location within its respective flash memory IC throughout its lifetime.

One method of managing memory, such as flash memory module 14a, is to form separate groups of physical blocks, which have the same associated position number. Each of such groups is called a “super block.” As an example of such grouping, FIG. 4 illustrates a super block 14a_{SB1}, which comprises all physical blocks that have associated position number 1. Because each physical block of a super block is from a different flash memory IC, each physical block within a super block may be erased simultaneously. Thus, instead of being constrained to erase only one physical block at a time in an entire flash memory module, as was once the case when only one prior art flash memory IC was used, the division of the flash memory module into multiple flash memory ICs enabled host 12 to erase multiple blocks of data by specifying a super block.

Later, flash memory ICs were developed such that a single flash memory IC was divided into planes (or “districts”) of blocks, and multiple blocks, each from different planes, could be erased at the same time. An example of the latter memory was marketed by Toshiba Corporation as product No. TC58NVG3D4CTG10. FIG. 5 illustrates physical block addresses of a flash memory module 14b, which comprises a single flash memory IC divided into planes 14b₁, 14b₂, 14b₃, . . . , 14b_{N}.

For flash memory ICs that are divided into planes in this fashion, the position number associated with a particular block indicates the block's physical location within its respective plane (as opposed to within the entire IC), and super blocks are formed of multiple physical blocks, each from different planes. For example, a super block 14b_{SB1} comprises all physical blocks of flash memory module 14b that have associated position number 1. Accordingly, even though flash memory module 14b has only one flash memory IC, the division of the flash memory IC into multiple planes enables host 12 to erase multiple blocks of data by specifying a super block.

The preceding discussion uses the term “plane” to identify a subset of the physical blocks of a single flash memory IC; however, the term “plane” is also used to identify the set of all physical blocks of the flash memory IC of the earlier type. For example, with reference to FIG. 4, each flash memory IC 14a₁, 14a₂, 14a₃, . . . , 14a_{N} of flash memory module 14a has only one plane, and flash memory module 14a has N planes total. With reference to FIG. 5, flash memory module 14b also has N planes, although all planes are part of a single flash memory IC. If a flash memory module had multiple flash memory ICs, and the flash memory ICs had multiple planes, the total number of planes of the flash memory module would be the sum of the planes of each flash memory IC.

When a physical block become defective, the entire super block of a flash memory module is rendered inoperative. FIGS. 6a and 6b illustrate an example flash memory module 14c having four planes 14c₁, 14c₂, 14c₃, and 14c₄, each of which has five physical blocks, resulting in a total of twenty blocks. The four planes may be part of a single integrated circuit, or they may be divided among two, three, or four integrated circuits. Because the planes each have five physical blocks, flash memory module 14c has five super blocks 14c_{SB1}, 14c_{SB2}, 14c_{SB3}, 14c_{SB4}, and 14c_{SB5}.

FIG. 6a indicates by shading that the defective blocks are those with physical block addresses 31, 22, 24, and 44, which is twenty percent of the total memory. However, because an entire super block is rendered inoperative if it has even one defective physical block, a total of twelve physical blocks are unavailable for use, which is 60 percent of the total memory. FIG. 6b indicates visually by shading that the blocks rendered unavailable are significantly more than just the blocks that are defective.

Of course, the number and the physical block addresses of the defective blocks of FIGS. 6a and 6b are illustrative examples of the effect of defective physical blocks on the total number of physical blocks that are available for use. Nonetheless, there exits a need for a way to increase the usage of the non-defective physical blocks in a NAND flash memory, which groups physical blocks together into super blocks.

### SUMMARY

The present invention enables increased usage of the non-defective physical blocks of a NAND flash memory by allowing logical super blocks to have physical blocks with different associated position numbers within their respective planes. The invention may be embodied as a method of managing physical blocks of the flash memory, a flash memory system for managing data transfer between a host and the flash memory ICs, or a machine readable storage medium containing instructions for a controller to organize physical blocks of flash memory.

The inventive method of managing physical blocks of flash memory includes providing one or more flash memory ICs and defining logical super blocks in a way that results in at least one of the logical super blocks having at least two physical blocks with different associated position numbers within their respective planes. Each flash memory IC has multiple physical blocks being grouped into planes such that two physical blocks from a common plane cannot be erased simultaneously, and two physical blocks from different planes can be erased simultaneously. The physical blocks have associated position numbers within the planes such that a position number indicates a block's physical location within its plane. The logical super blocks are defined as groups of multiple physical blocks having no more than one physical block from a common plane to allow all physical blocks within a super block to be erased simultaneously.

The inventive flash memory system for managing data transfer between a host and the flash memory ICs includes a flash memory module and a controller. The flash memory module may be part of a portable data storage assembly, for example, a USB flash drive. The controller may also be part of the portable data assembly, or it may reside in the host, for example, implemented as software executable by the host. The controller is operative to manage data transfer between the flash memory module and the host by defining the logical super blocks.

The inventive machine readable storage medium contains instructions for a controller to organize physical blocks of flash memory by obtaining the physical blocks' position numbers and defining logical super blocks in a way that results in at least one of the logical super blocks having at least two physical blocks with different associated position numbers within their respective planes.

Embodiments of the present invention are described in detail below with reference to the accompanying drawings, which are briefly described as follows:

### BRIEF DESCRIPTION OF THE DRAWINGS

The invention is described below in the appended claims which are read in view of the accompanying description including the following drawings, wherein:

FIG. 1 illustrates a prior art memory management system;

FIG. 2 depicts a prior art flash memory module, which may be used in the system of FIG. 1;

FIG. 3 represents the prior art flash memory module of FIG. 2 with the physical block addresses indicated for each memory block;

FIG. 4 shows a prior art grouping of the physical blocks of FIG. 3 into super blocks;

FIG. 5 shows a prior art super block grouped from physical blocks of a single flash memory module having multiple planes;

FIGS. 6a and 6b illustrate the effects of defective physical blocks on prior art super blocks;

FIG. 7 illustrates a flash memory system according to one an embodiment of the invention;

FIG. 8 presents a flow chart representing an algorithm according to one embodiment of the invention;

FIG. 9 presents a comparison of the results of using the memory management of the prior art and the memory management of the embodiment represented in FIG. 8; and

FIG. 10 presents a flow chart representing an algorithm according to an alternate embodiment of the invention.

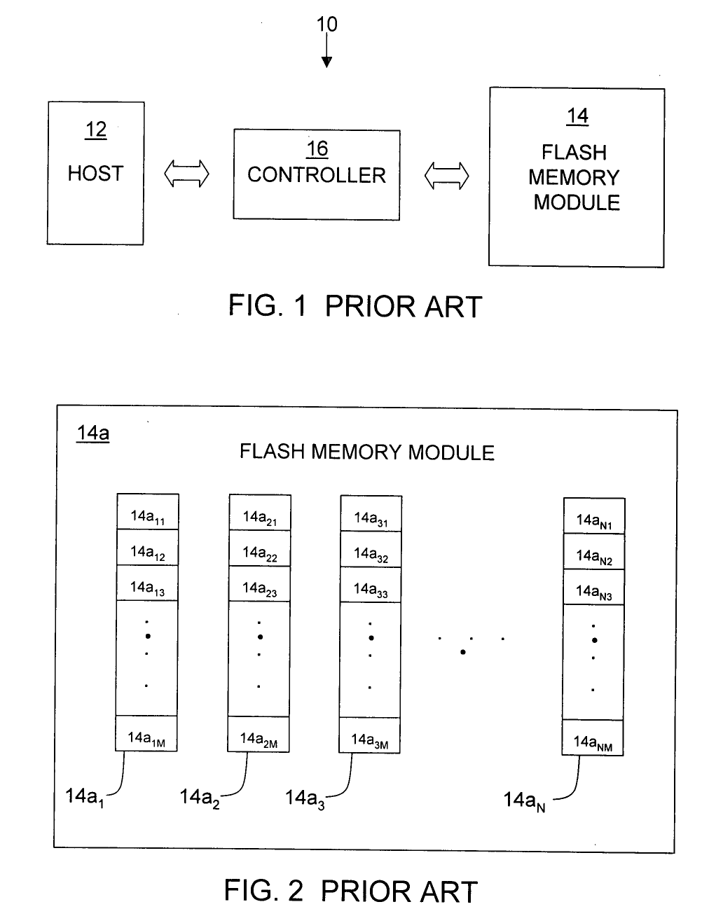

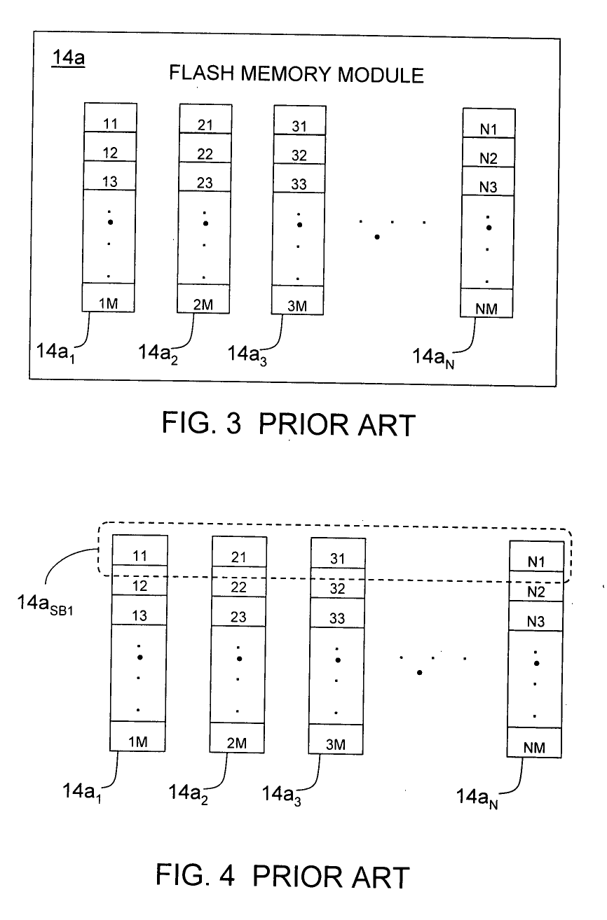

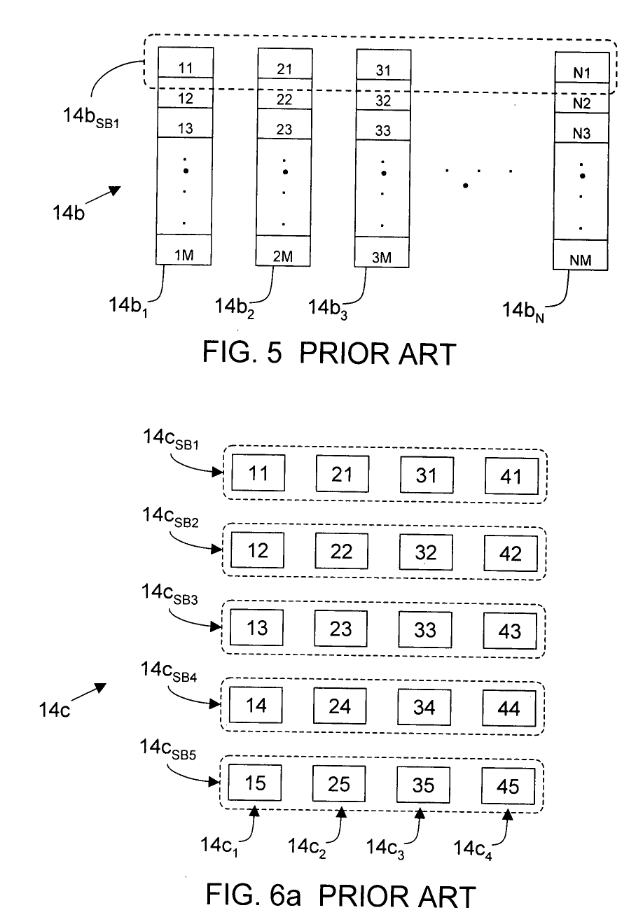

### DETAILED DESCRIPTION

The invention summarized above and defined by the claims below will be better understood by referring to the present detailed description of embodiments of the invention. This description is not intended to limit the scope of claims but instead to provide examples of the invention. Described first is a flash memory system that manages data transfer between a host and flash memory ICs. Included are descriptions of exemplary algorithms that instruct the controller in managing the data transfer. Also presented is a comparison of super block mapping of the prior art with super block mapping of the present invention.

Reference is now made to FIG. 7, which illustrates an exemplary embodiment of a flash memory system 20 that manages data transfer between a host and flash memory ICs. Flash memory system 20 has a flash memory module 24 and a controller 26. Flash memory module 20 may be part of a portable data storage assembly, for example, a USB flash drive. Controller 26 may also be part of the portable data assembly, or it may reside instead in the host. For example, controller 26 may be implemented by software executable by the host.

Flash memory module 24 has one or more flash memory ICs, and each flash memory IC has multiple physical blocks, which are identified by their physical block addresses 11, 12, 13, . . . , 45. Specifically, in this embodiment, physical blocks 11, 12, 13, . . . , 45 are grouped into planes 24₁, 24₂, 24₃, and 24₄. Two physical blocks from a common plane cannot be erased simultaneously, but two physical blocks from different planes can be erased simultaneously. Physical blocks 11, 12, 13, . . . , 45 have associated position numbers within their respective planes such that a position number indicates a block's physical location within its plane.

Controller 26 is operative to manage data transfer between flash memory module 24 and a host by defining logical super blocks as groups of multiple physical blocks, each logical super blocks having no more than one physical block from a common plane to allow all physical blocks within a super block to be erased simultaneously. Unlike the super blocks of the prior art, however, a logical super block of the present invention may have physical blocks with different associated position numbers within their respective planes, and designation of logical super blocks accordingly can enable greater usage of the non-defective physical blocks of a NAND flash memory.

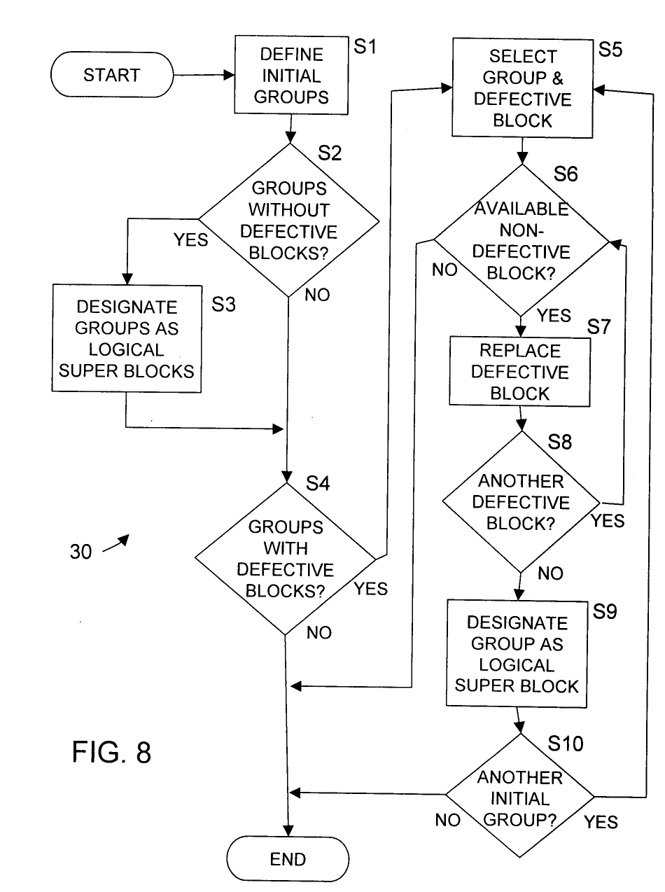

Controller 26 accesses a machine readable storage medium containing instructions that, when executed, cause the controller to perform as described herein. One exemplary algorithm executable by controller 26 is represented by the flow chart 30 in FIG. 8. This algorithm will be explained with reference to flash memory module 24. The defective physical blocks therein are physical blocks 31, 22, 24, and 44, which FIG. 7 indicates by shading.

Controller 26 begins by obtaining the position numbers associated with all physical blocks 11, 12, 13, . . . , 45 and then defines initial groups of the physical blocks, each initial group having no more than one physical block from a common plane. [Step S1.] Applying this logic to flash memory module 24 yields the initial groups such as {11, 21, 31, 41}, {12, 22, 32, 42}, {13, 23, 33, 43}, {14, 24, 34, 44}, and {15, 25, 35, 45}.

Next, controller 26 determines whether any initial groups have no defective blocks. [Step S2.] For each initial group having no defective physical blocks, controller 26 designates the physical blocks as a logical super block. [Step S3.] Applying this logic to the initial groups flash memory module 24 yields logical super groups such as {13, 23, 33, 43} and {15, 25, 35, 45}.

Then, controller 26 determines if there are initial groups that have defective physical blocks. [Step S4.] When no such initial groups remain, the algorithm ends.

For the example application of this algorithm to flash memory module 24, controller 26 determines that the following three such initial groups remain: {11, 21, 31, 41}, {12, 22, 32, 42}, and {14, 24, 34, 44}. The defective physical blocks are noted in underscore.

For such applications in which initial groups are found that have defective physical blocks, controller 26 selects one of such initial groups and then selects a defective physical block from that group. [Step S5.] For the present example, controller 26 might select initial group {11, 21, 31, 41} and then physical block 31.

Next, controller 26 determines whether the plane of the selected physical block includes a non-defective physical block that is not yet designated as part of a logical super block. [Step S6.] For the present example, controller 26 can identify either physical block 32 or physical block 34 as available. If no such physical blocks are available from the plane of the selected defective physical block, the algorithm ends.

For applications such as the present example, in which non-defective physical blocks are available, controller 26 redefines the selected initial group by replacing the selected defective physical block with an available non-defective physical block. [Step S7.] For the present example, controller 26 may redefine the selected initial group by replacing defective physical block 31 with non-defective physical block 32.

Then, controller 26 determines whether the selected initial group has another defective physical block. [Step S8.] When the selected initial group does not have another defective physical block, controller 26 designates the physical blocks of the redefined initial group as a logical super block. [Step S9.] For the present example of flash memory module 24, controller 26 may designate physical blocks 11, 21, 32, and 41 as a logical super block. For applications in which the selected initial group does have another defective physical block, the process flow continues to Step S6 to determine whether another non-defective physical block is available for use in a logical super block.

After Step S9, when a logical super block is designated, controller 26 determines whether another initial group having at least one defective physical block exists. [Step S110.] If no such initial group exists, as in the case of the example flash memory module 24, the process flow ends. If at least one such initial group exists, the process flow continues to Step S6 and controller 26 repeats the above-described logic to determine whether another logical super block can be designated. When the algorithm ends, the logical super blocks are determined, and multiple physical blocks corresponding to a common logical super block may be erased substantially simultaneously.

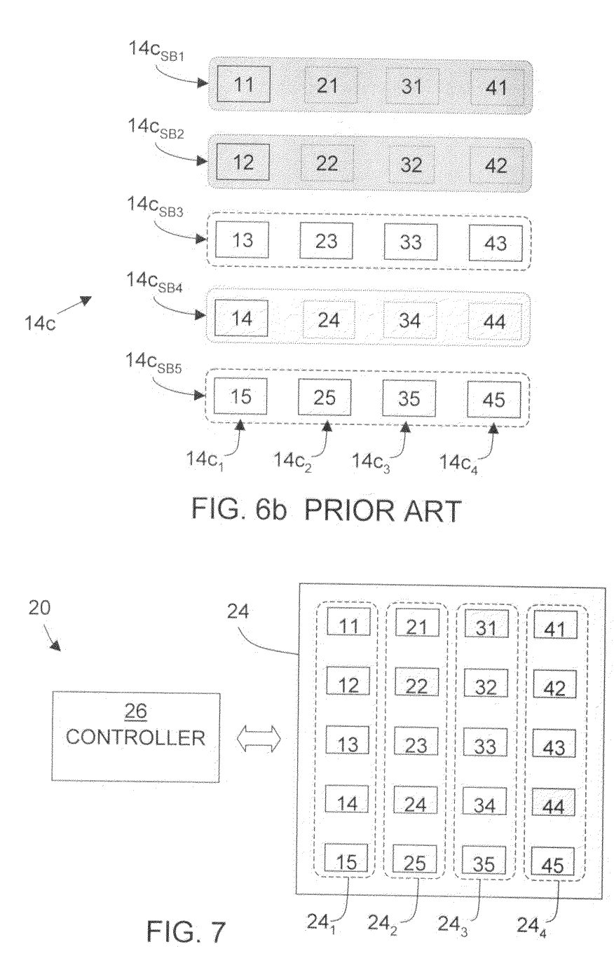

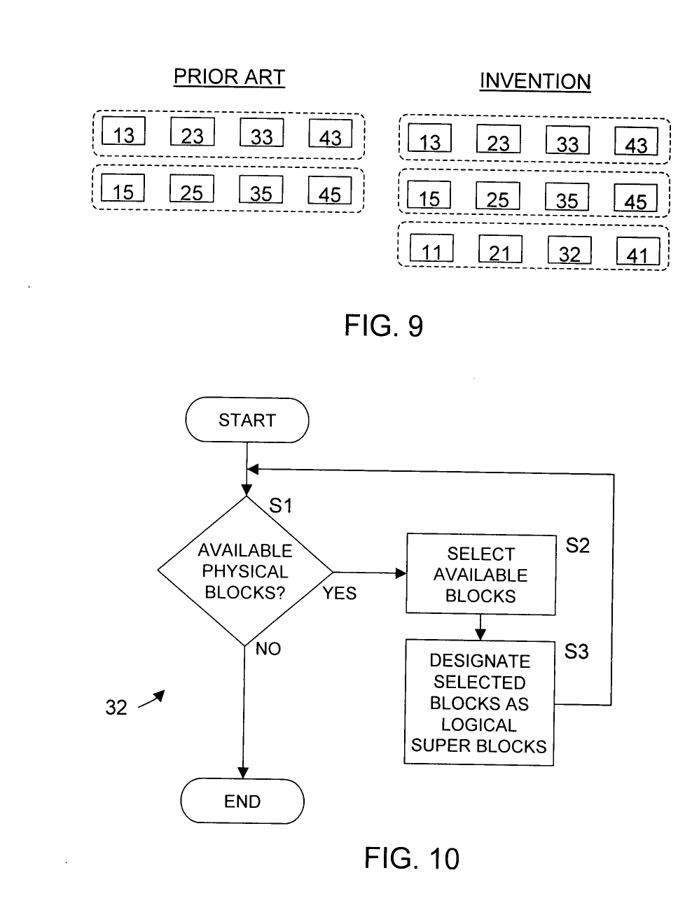

The present invention enables greater usage of the non-defective physical blocks of a NAND flash memory. In the prior art described above, only forty percent of flash memory module 14c is available for use in super blocks. (See, in particular, FIG. 6b.) However, in the embodiment described immediately above, the controller 26 would designate sixty percent of the same flash memory module as available for use in logical super blocks. This increase in available memory is shown graphically in FIG. 9 with dashed lines indicating super blocks.

As is evident from FIG. 9, the available memory can be increased by allowing logical super blocks to have physical blocks with different associated position numbers within their respective planes. For the embodiment of the invention discussed above, the third logical super block has three physical blocks having associated position numbers 1 (physical blocks 11, 21, and 41) and one physical block having position number 2 (physical blocks 32).

To the best knowledge of the inventors, the only situations in which the present embodiment would not increase the capacity of a NAND flash memory would be: (1) when every initial group of physical blocks having defective blocks has a deflective block in the same plane; and (2) when the initial groups of physical blocks have no deflective physical blocks at all. Both scenarios are regarded as rare. Only in those situations would all logical super blocks of a memory each have all physical blocks with the same associated position numbers. Nonetheless, if the disclosed embodiment were applied to such a situation, the same amount of memory would be available for use, instead of less memory being available for use. That is, implementation of the present embodiment is not anticipated to have the risk of providing less memory for use than what would be provided using the prior art discussed above.

FIG. 10 illustrates an alternative embodiment of the invention in which flow chart 32 represents another algorithm executable by a controller to increase usage of NAND flash memory beyond the usage of prior art algorithms. The controller begins by determining whether each plane of the flash memory includes at least one non-defective physical block that is not yet designated as part of a logical super block. [Step S1.] The determination is negative if one or more planes do not have an available non-defective super block, and the algorithm ends.

If the determination of Step S1 is positive, that is, if each plane of the flash memory includes at least one available block, the controller selects one of such available blocks from each plane. [Step S2.] Then, the selected blocks are designated as a new logical super block. [Step S3.]

Next, the process flow continues to Step S1, and the controller determines again whether each plane of the flash memory module includes at least one non-defective physical block that is not yet designated as part of a logical super block. This process repeats until at least one plane does not include a non-defective physical block that is not yet designated to a logical super block. When the algorithm ends, the logical super blocks are determined, and multiple physical blocks corresponding to a common logical super block may be erased substantially simultaneously.

As with the embodiment represented in FIG. 8, the present embodiment enables greater usage of the non-deflective physical blocks of a NAND flash memory. By allowing logical super blocks to have physical blocks with different associated position numbers, the available memory can be increased.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

We claim:

1. A method of managing physical blocks of flash memory, the method comprising:
providing one or more flash memory ICs such that each flash memory IC has multiple physical blocks, said physical blocks being grouped into planes wherein two physical blocks from a common plane cannot be erased simultaneously, and wherein two physical blocks from different planes can be erased simultaneously, said physical blocks having associated position numbers within said planes such that a position number indicates a block's physical location within its plane; and
defining logical super blocks as groups of multiple physical blocks, each of said logical super blocks having no more than one physical block from a common plane to allow all physical blocks within a super block to be erased simultaneously,
wherein at least one of said logical super blocks has at least two physical blocks with different associated position numbers within their respective planes.

2. The method of claim 1, wherein said logical super blocks are defined by implementing the following process:
defining initial groups of physical blocks, each of said initial groups having no more than one physical block from a common plane;
for each initial group having no defective physical blocks, designating said physical blocks of such initial group as a logical super block; and
for each initial group having at least one defective physical block:
for each defective physical block in said initial group, when the plane of said defective physical block includes a non-defective physical block that is not yet designated as part of a logical super block, redefining said initial group of physical blocks by replacing said defective physical block with said non-defective and not-yet-designated physical block; and
after said replacing occurs for each defective block in said initial group, designating the physical blocks of said redefined group as a logical super block.

3. The method of claim 1, wherein said logical super blocks are defined by implementing the following process:
when each plane includes at least one non-defective physical block that is not yet designated as part of a logical super block, designating one of said not-yet-designated non-defective physical blocks from each plane as a new logical super block; and
repeating said designating until at least one plane does not include a non-defective physical block that is not yet designated to a logical super block.

4. The method of claim 1, further comprising:
erasing, substantially simultaneously, multiple physical blocks corresponding to a common logical super block.

5. A flash memory system for managing data transfer between a host and flash memory ICs, the flash memory system comprising:
a flash memory module, having one or more flash memory ICs with each flash memory IC having multiple physical blocks, said physical blocks grouped into planes such that two physical blocks from a common plane cannot be erased simultaneously and that two physical blocks from different planes can be erased simultaneously, said physical blocks having associated position numbers within said planes such that a position number indicates a block's physical location within its plane;
a controller operative to manage data transfer between said flash memory module and the host by defining logical super blocks as groups of multiple physical blocks, each of said logical super blocks having no more than one physical block from a common plane to allow all physical blocks within a super block to be erased simultaneously,
wherein at least one of said logical super blocks has at least two physical blocks with different associated position numbers within their respective planes.

6. The flash memory system of claim 5, wherein said controller is further operative to erase, substantially simultaneously, multiple physical blocks corresponding to a common logical super block.

7. The flash memory system of claim 5, wherein said flash memory module and said controller are part of a portable data storage assembly.

8. The flash memory system of claim 7, wherein said portable data storage assembly is a USB flash drive.

9. The flash memory system of claim 5, wherein said flash memory module is part of a portable data storage assembly and said controller resides in the host.

10. The flash memory system of claim 9, wherein said controller is implemented by software executable by the host

11. The flash memory system of claim 9, wherein said portable data storage assembly is a USB flash drive.

12. The flash memory system of claim 5, wherein said controller is operative to define said logical super blocks by implementing the following process:
defining initial groups of physical blocks, each of said initial groups having no more than one physical block from a common plane;
for each initial group having no defective physical blocks, designating said physical blocks of such initial group as a logical super block; and
for each initial group having at least one defective physical block:
for each defective physical block in said initial group, when the plane of said defective physical block includes a non-defective physical block that is not yet designated as part of a logical super block, redefining said initial group of physical blocks by replacing said defective physical block with said non-defective and not-yet-designated physical block; and
after said replacing occurs for each defective block in said initial group, designating the physical blocks of said redefined group as a logical super block.

13. The flash memory system of claim 5, wherein said controller is operative to define said logical super blocks by implementing the following process:
when each plane includes at least one non-defective physical block that is not yet designated as part of a logical super block, designating one of said not-yet-designated non-defective physical blocks from each plane as a new logical super block; and
repeating said designating until at least one plane does not include a non-defective physical block that is not yet designated to a logical super block.

14. A machine readable storage medium containing instructions for a controller to organize physical blocks of flash memory, said flash memory having one or more flash memory ICs with each flash memory IC having multiple physical blocks, said physical blocks grouped into planes such that two physical blocks from a common plane cannot be erased simultaneously and that two physical blocks from different planes can be erased simultaneously, said physical blocks having associated position numbers within said planes such that a position number indicates a block's physical location within its plane, wherein when executed said instructions cause said controller to perform the following:
define logical super blocks as groups of multiple physical blocks, each of said logical super blocks having no more than one physical block from a common plane to allow all physical blocks within a super block to be erased simultaneously, at least one of said logical super blocks having at least two physical blocks with different associated position numbers within their respective planes; and
erase, substantially simultaneously, multiple physical blocks corresponding to a common logical super block.

15. The machine readable storage medium of chain 14, wherein said instructions for defining said logical super blocks include the following:
defining initial groups of physical blocks, each of said initial groups having no more than one physical block from a common plane;
for each initial group having no defective physical blocks, designating said physical blocks of such initial group as a logical super block; and
for each initial group having at least one defective physical block:
for each defective physical block in said initial group, when the plane of said defective physical block includes a non-defective physical block that is not yet designated as part of a logical super block, redefining said initial group of physical blocks by replacing said defective physical block with said non-defective and not-yet-designated physical block; and
if said replacing occurs for each defective block in said initial group, designating the physical blocks of said redefined group as a logical super block.

16. The machine readable storage medium of claim 14, wherein said instructions for defining said logical super blocks include the following:
when each plane includes at least one non-defective physical block that is not yet designated as part of a logical super block, designating one of said net-yet-designated non-defective physical blocks from each plane as a new logical super block; and
repeating said designating until at least one plane does not include a non-defective physical block that is not yet designated to a logical super block.
